(19) United States
(12) Patent Application Publication
(10) Pub. No.: US 2015/0089612 A1
(43) Pub. Date: Mar. 26, 2015

(54) CLOUD STORAGE SERVER AND MANAGEMENT METHOD THEREOF

(71) Applicant: Institute For Information Industry, Taipei (TW)

(72) Inventors: Yen-Hung KUO, Taipei City (TW); Yu-Lin JENG, Tainan City (TW)

(73) Assignee: Institute For Information Industry, Taipei (TW)

(21) Appl. No.: 14/032,440

(22) Filed: Sep. 20, 2013

(51) Int. Cl. H04L 29/06; G06F 21/31

(52) U.S. Cl. CPC H04L 63/083; G06F 21/31
USPC 726/7; 726/6

(57) ABSTRACT

A cloud storage server and a management method thereof are provided. The cloud storage server runs a management program for managing and sharing a plurality of resources. When a user wants to share a resource stored in the cloud storage server to a target address, the cloud storage server creates a share link of the shared resource and delivers the share link to a target address. After the user receives the share link from the target address, the user can set his own password for accessing the cloud storage server via the share link and download the shared resource.

### FIELD

The present invention relates to a cloud storage server and a management method thereof. In particular, the present invention provides a management mechanism. Using this management mechanism, the user can set his/her own password to access the cloud storage server via a share link and download the shared resources corresponding to the share link.

### BACKGROUND

With the progress of computer technologies, various user devices (e.g. smart phones, notebooks, personal computers etc.) have been used for Internet connectivity. Over recent years, several organizations have provided cloud storage services for registered users to store their files and share the files or folders with other people by sending a message with a share link.

For security issues, people usually use additional passwords to protect the share link. However, in some situations, the password is delivered verbally, e.g. over the phone or in person, which can be difficult to remember. In addition, it may be difficult to manage these share links, especially when they are sent to various contact addresses, such as email addresses, instant messaging (IM) addresses, social network accounts etc. In this case, it is difficult for a user to manage such a wide distribution of share links delivered to his/her multiple contact addresses.

Accordingly, efforts still have to be made in this field to provide a management mechanism which can effectively resolve the security and management issues of share links.

### SUMMARY

An objective of certain embodiments of this invention is to provide a management mechanism which can effectively resolve the security and management issues of share links. The management mechanism can allow a share link receiver to use self-defined passwords to protect the shared resource that has been shared. In addition, multiple contact addresses of a single user are linked together with the creation of a user profile.

To achieve the aforesaid objective, the present invention according to certain embodiments discloses a cloud storage server. The cloud storage server comprises a storage medium, a network interface and a processor. The storage medium is configured to store a management program and a plurality of resources. The network interface is connected to a network. The processor is configured to run the management program to execute the following steps: (a) receiving a first share request for sharing a first selected resource of the resources to a first target address via the network interface; (b) creating a first share link of the first selected resource with an initial state for the first target address; (c) delivering the first share link to the first target address via the network interface; (d) receiving an activation request from a user device corresponding to the first target address via the network interface, wherein the activation request includes an identification code and a user password corresponding to the first share link and the activation request is generated by the user device when accessing the cloud storage server via the first share link; (e) determining whether the identification code matches the first target address; and (f) transiting the first share link from the initial state to an activated state if the identification code matches the first target address.

In addition, the present invention further includes a management method for use in a cloud storage server to achieve the aforesaid objective. The cloud storage server comprises a storage medium, a network interface and a processor. The storage medium stores a management program for the management method and a plurality of resources. The network interface is connected to a network. The processor is electrically connected to the network interface and the storage medium, and runs the management program to execute the management method. The management method comprises the following steps: (a) receiving a first share request for sharing a first selected resource of the resources to a first target address via the network interface; (b) creating a first share link of the first selected resource with an initial state for the first target address; (c) delivering the first share link to the first target address via the network interface; (d) receiving an activation request from a user device corresponding to the first target address via the network interface, wherein the activation request includes an identification code and a user password corresponding to the first share link and the activation request is generated by the user device when accessing the cloud storage server via the first share link; (e) determining whether the identification code matches the first target address; and (f) transiting the first share link from the initial state to an activated state if the identification code matches the first target address.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a cloud storage server 11 connected to a network 13;

FIG. 2 is a schematic view of the cloud storage server 11 of the present invention;

FIG. 3A is a schematic view of a web page WP1 according to the first embodiment;

FIG. 3B is a schematic view of a web page WP2 according to the first and fourth embodiments;

FIG. 3C is a schematic view of a web page WP3 according to the first embodiment;

FIG. 4 is a schematic view of a web page WP4 according to the second embodiment;

FIG. 5 is a schematic view of a web page WP5 according to the third embodiment;

FIG. 6 is a schematic view of a web page WP6 according to the fifth embodiment; and

FIG. 7 is a flowchart diagram of a management method according to the sixth embodiment.

### DETAILED DESCRIPTION

In the following description, the present invention will be explained with reference to example embodiments thereof. However, these example embodiments are not intended to limit the present invention to any specific example, embodiments, environment, applications or particular implementations described in these embodiments. Therefore, the description of these example embodiments is only for the purpose of illustration rather than to limit the present invention. In the following embodiments and attached drawings, elements not directly related to the present invention are omitted from depiction; and the dimensional relationships among the individual elements in the attached drawings are illustrated only for ease of understanding, but not to limit the actual scale.

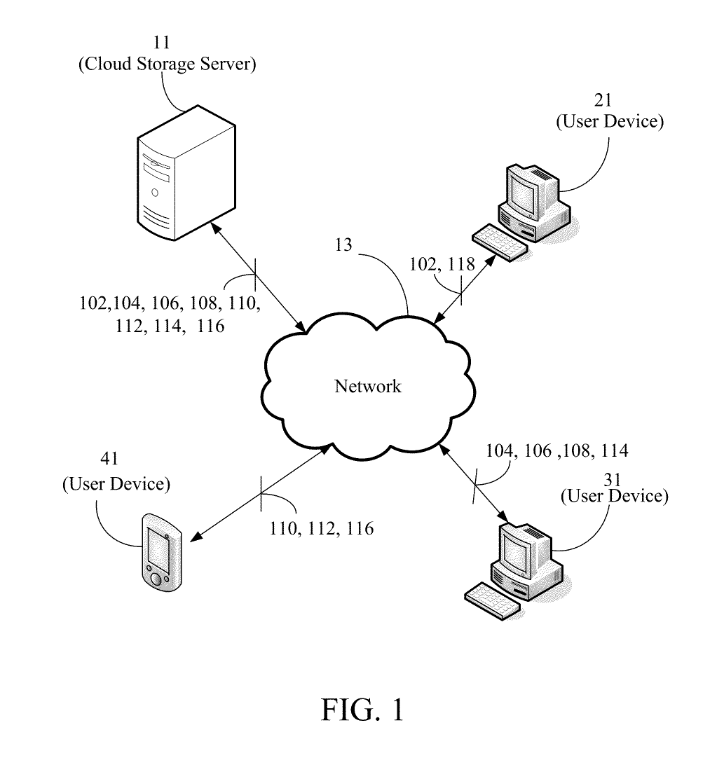

The first embodiment of the present invention is depicted in FIG. 1, which illustrates a cloud storage server 11 connected to a network 13. The cloud storage server 11 provides a cloud storage server and runs a management program for managing the user's resources, share links for multiple target addresses and user profiles that may be associated with one or more contact addresses.

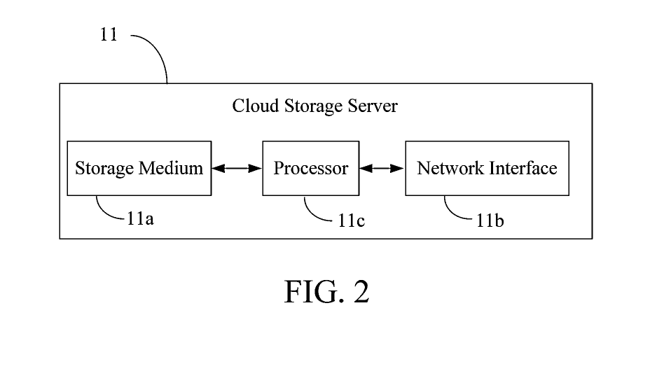

Further, with reference to FIG. 2, the cloud storage server 11 includes a storage medium 11a, a network interface 11b and a processor 11c. The storage medium 11a stores the management program and a plurality of resources (e.g. files, folders, etc.) created and uploaded by users. The storage medium may be a tangible machine-readable medium or a combination of multiple tangible machine-readable medium for providing the integration apparatus with a permanent storage, such as a read only memory (ROM), a flash memory, a hard disk, or any other storage media with the same function and well known to those skilled in the art. The network interface 11b is connected to the network 13. The processor 11c is electrically connected to the storage medium 11a and the network interface 11b. The processor 11c runs the management program to execute several operations and accomplish specific functions for management purposes.

When a registered user would like to share a first selected resource stored in the storage medium 11a to a first target address, the registered user accesses the cloud storage server 11 through the user device 21 (e.g. a personal computer) and sends a first share request 102 with the first target address (e.g. an email address) for sharing the first selected resource to the first target address. It is noted that the first share request 102 may be generated and sent by operating the web interface and the specific application designed for the cloud storage server 11 on the user device 21.

After receiving the first share request 102 via the network interface 11b, the processor 11c creates a first share link 104 of the first selected resource with an initial state for the first target address. In the present invention, every share link created by the processor 11c is unique and assigned to a specific target address. Next, the processor 11c delivers the first share link 104 to the first target address via the network interface 11b. Because the first target address is the email address, the first share link 104 is delivered to the first target address via an e-mail. However, in other embodiments, if the target address is a mobile phone number, the share link is delivered to the target address via a Short Message Service (SMS) message, a Multimedia Messaging Service (MMS) message, or an instance message in mobile APP. Since the means to deliver the share link depends on the type of target address and has well been appreciated by people skilled in this field, it will not be further described herein.

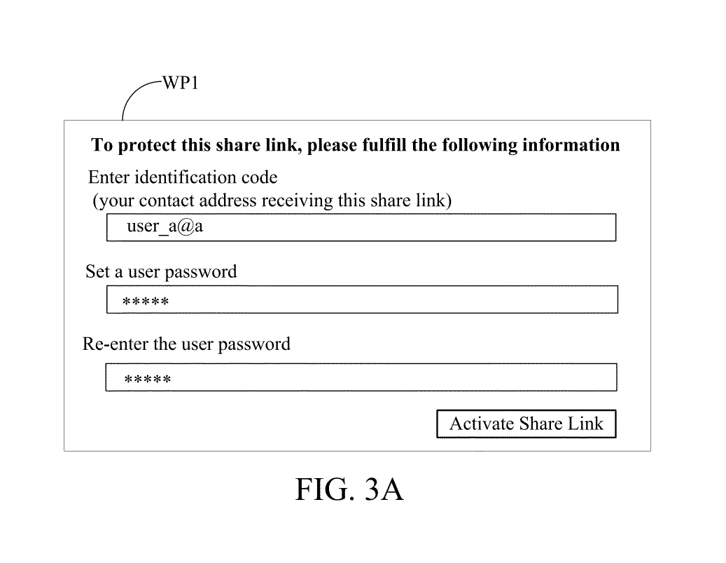

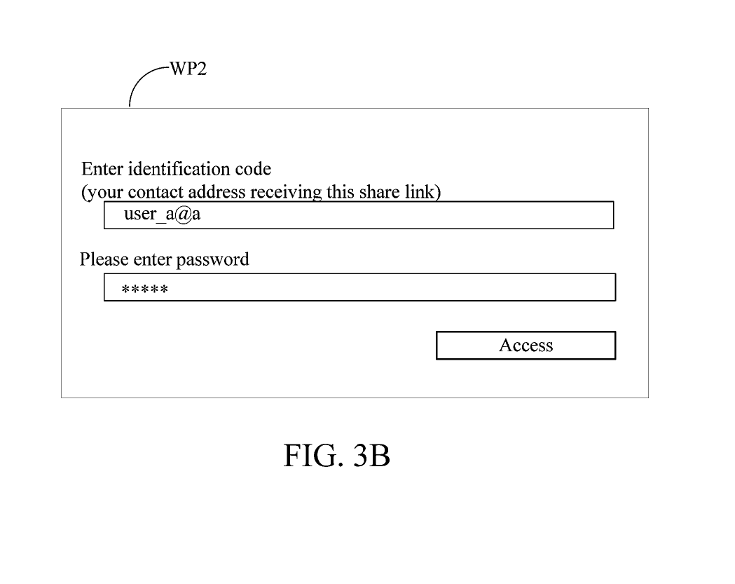

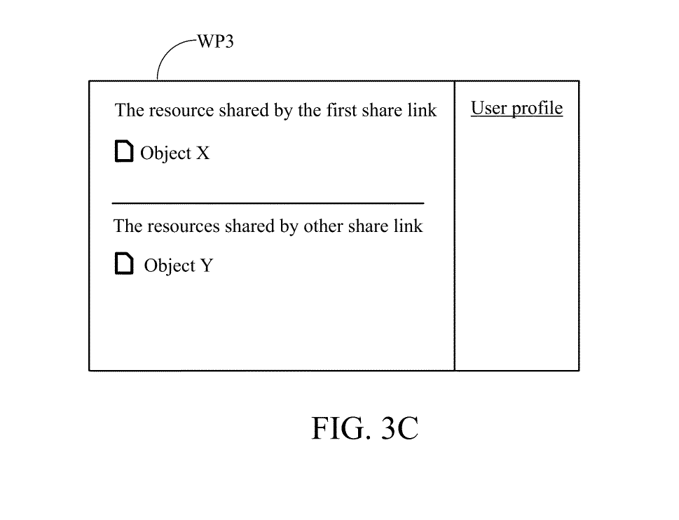

A receiver with the first target address receives the first share link 104 and accesses the cloud storage server 11 via the first share link 104 through the user device 31. The first share link 104 brings the receiver to a web page WP1 as shown in FIG. 3A to fill the required information. In this embodiment, the required information includes the identification code and a user password of the first share link 104. The identification code is the receiver's contact address that receives the share link 104, and it should be identical to the target address for activating the first share link 104. The user password is currently defined by the receiver. Once the receiver fulfills the required information and clicks the “Activate Share Link” button, the user device 31 generates an activation request 106 including the identification code and the user password corresponding to the first share link 104 and sends the activation request 106 to the cloud storage server 11.

Next, the processor 11c receives the activation request 106 via the network interface 11b and determines whether the identification code included in the activation request 106 matches the first target address. If the identification code matches the first target address, the processor 11c transits the first share link 104 from the initial state to an activated state. Once the first share link 104 has been in the activated state, the activated first share link 104 brings the receiver to a web page WP2 as shown in FIG. 3B when the next time the receiver accesses the cloud storage server 11 via the first share link 104.

On the web page WP2, the receiver can enter the identification code (i.e. the first target address) and the self-defined password (i.e. the user password) and click the “Access” button to access the cloud storage server 11. The “Access” button navigates the receiver to the web page WP3 as shown in FIG. 3C from the web page WP2. The web page WP3 is a resource list on which the resources shared to the first target address are placed and navigated from the web page WP1 or the web page WP2. As shown in FIG. 3C, the Object X (i.e. the first selected resource) is placed on the resource list. Furthermore, other resources (e.g. the Object Y) shared to the same receiver with the first target address via other share links may be also placed on the resource list.

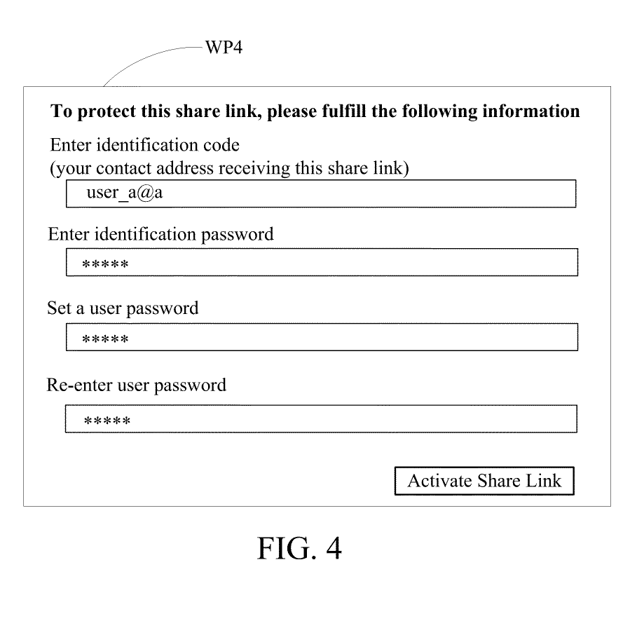

The second embodiment of the present invention is depicted in FIG. 4, which illustrates a web page WP4 which the receiver visits via the first share link 104. In this embodiment, the required information which the receiver should fill further includes an identification password for activation. The identification password should be identical to an activation password that is set by the registered user before or when the first selected resource to the first target address is shared. The registered user can deliver the activation password named as the identification password personally, e.g. deliver via message transmitting (e.g. instant message) or verbally (e.g. phone calls or in person).

In this case, the activation request 106 delivered by the user device 31 not only includes the identification code and the user password but also the identification password. After receiving the activation request 106 via the network interface 11b, the processor 11c determines whether the identification code matches the first target address and whether the identification password matches the activation password. If both the identification code matches first target address and the identification password matches the activation password, the processor 11c transits the first share link 104 from the initial state to the activated state.

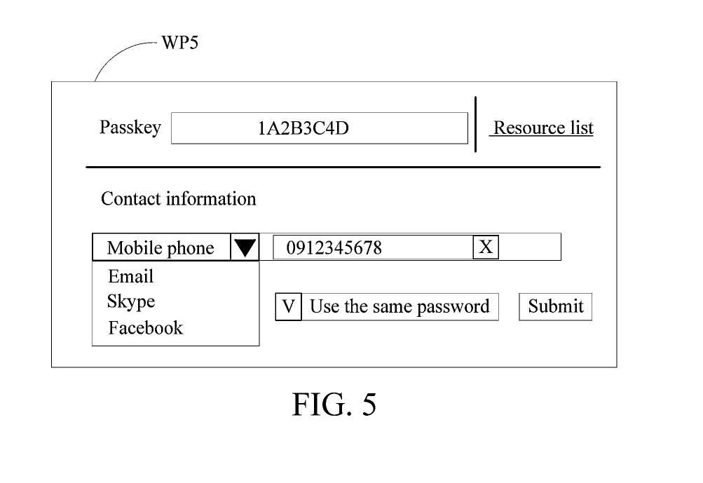

The third embodiment of the present invention is depicted in FIG. 5, which illustrates a user profile on a web page WP5. The web page WP5 can be navigated from the web page WP4 using the “User profile” link. The processor 11c creates the user profile with a pass key of the first target address 104 after the first share link 104 has been activated. The receiver can use user device 31 to operate the web WP5 by adding another contact address (e.g. a mobile phone number, a Skype account, a Facebook account or a email address) and then clicking the “Submit” button to link his/her contact addresses together. Using this operation, the processor 11c receives a first modification request 108 with a second target address (i.e. a contact address of the receiver) from the user device 31 via the network interface 11b. Afterwards, the process 11c creates a verification link 110 for the second target address and delivers the verification link 110 to the second target address via the network interface 11b.

For example, if the second target address is a mobile phone number, the verification link 110 may be delivered to the second target address via a multimedia messaging service (MMS). Following that, the receiver's user device 41 with the second target address receives the verification link 110 and accesses the cloud storage server 11 via the verification link 110. The verification code (i.e. the passkey) is then entered to send a verification request 112 to the cloud storage server 11. When the processor 11c receives the verification request 112 with the verification code from the user device 41 via the network interface 11b, the processor 11c determines whether the verification code matches the passkey. The user profile is updated by linking the second target address with the first target address if the verification code matches the passkey.

Moreover, the web page WP5 also provides a same password option for the receiver to use the same user password for a part or all of the contact addresses. As shown in FIG. 4, the receiver can use the user device 31 to operate the web WP5 by checking the option of “Use the same password”. Using this operation, the processor 11c receives a second modification request 114 with a password selection from the user device 31 via the network interface 11b. If the password selection indicates the receiver would like to use the same password, the processor 11c updates the user profile by changing the same password option among multiple contact addresses (i.e. target addresses) according to the second modification request 114. The same password option aids the receiver in managing his/her multiple contact addresses (i.e. target addresses) corresponding to the multiple share links.

The fourth embodiment of the present invention is also referred to in FIG. 3B. In this embodiment, the receiver also receives a second share link 116 delivered to a second target address and access the cloud storage server 11 via the second share link 116. In addition, the second target address is assumed to have been linked with the first target address and set to the same user password through the operations described in the third embodiment.

Specifically, in a situation when the processor 11c receives a second share link request 118 for sharing a second selected resource of the resources to the second target address, the processor 11c determines whether the second target address is included in the user profile and further determines whether the second target address is linked with the first target address and set to the same user password if the second target address is included in the user profile. If the second target address is linked with the first target address and set to the same user password, the processor 11c creates a second share link 116 of the second selected resources with the activated state for the second target address.

Next, the processor 11c delivers the second share link 116 to the second target address via the network interface 11b. For example, the second target address is the mobile phone number assigned to the user device 41 of the receiver. Since the receiver has added his mobile phone number (i.e. the second target address) to the user profile, it linked the mobile phone number with the email address (i.e. the first target address) and set the same user password, the second share link 116 will bring the receiver to the web page WP2 as shown in FIG. 3B. In this situation, the receiver can directly enter the identification code (i.e. the second target address) and the self-defined password (i.e. the user password) and click the “Access” button to access the cloud storage server 11.

It is noted that if the second target address is not included in the user profile or not linked with the first target address and set to the same user password, the receiver has to set the user password for the second target address as shown in FIG. 3A and may further need to enter the identification password as shown in FIG. 4. Furthermore, if the user device 41 is a smart phone or a Tablet PC, the receiver can use a web application or a specific application designed for the cloud storage server 11 to open the second share link 114 to access the cloud storage server 11. Since people skilled in this field can easily appreciate the methods of opening the share link on a smartphone or Tablet PC, this will not be further described herein.

In another situation when the registered user would like to share the first selected resource stored in the storage medium 11a to both the first target address and the second target address at the same time, the processor 11c then receives the first share request 102 for sharing the first selected resource of the resources to the first target address and the second target address via the network interface 11b. Then, the processor 11c creates the second share link 116 of the first selected resource with the initial state for the second target address and delivers the second share link 116 to the second target address via the network interface 11b.

When the receiver opens the first share link 104 first and has added his mobile phone number (i.e. the second target address) to the user profile, linked the mobile phone number with the email address (i.e. the first target address), and set to the same user password, the processor 11c will transit the second share link from the initial state to the activated state if the second target address is linked with the first target address and set to the same user password.

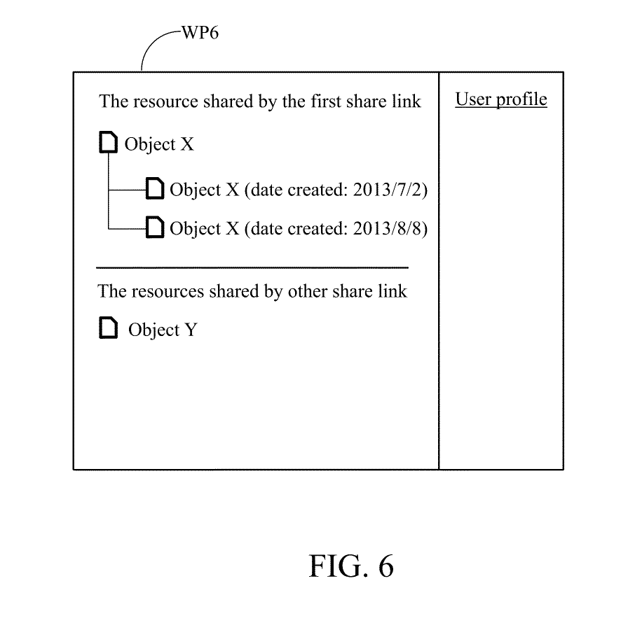

The fifth embodiment of the present invention is depicted in FIG. 6 illustrating a web page WP6. In this embodiment, the old versions of the first selected resource shared to the first target address are also placed on the resource list. Once the share link expires, the receiver is no longer allowed to download the last version of the selected resource corresponding to the share link. In the present invention, the processor 11c permits the receiver to download the old versions of the selected resource corresponding to the share link.

For example, as shown in FIG. 6, the old versions of the first selected resource (i.e. Object X) that is shared to the first target address is placed on the resource list as “Object X (date created: 2013 Jul. 2)” and “Object X (date created: 2013 Aug. 8). The receiver accessing the cloud storage server 11 via the first share link 104 can still download the old versions of the first selected resource after the first share link 104 is in an expired state as long as the old versions of the first selected resource has been downloaded ever.

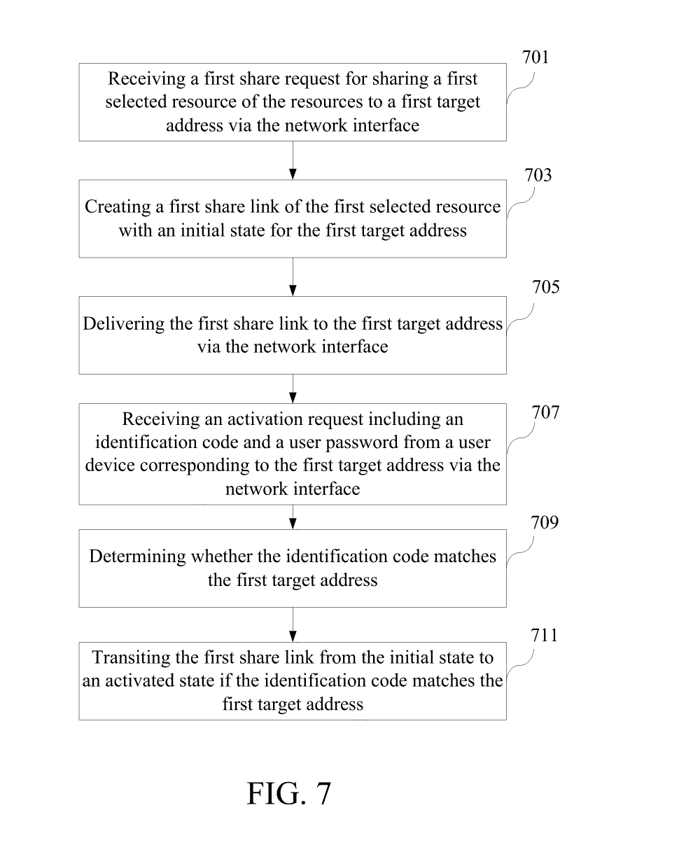

The sixth embodiment of the present invention is a management method for use in a cloud storage server; a flowchart of which is illustrated in FIG. 7. The management method of the present invention can be executed by a processor running the management program, such as the processor 11c of the cloud storage server 11 set forth in the foregoing embodiments. In addition to the processor, the cloud storage server has a storage medium and a network interface. The storage medium stores the management program for the management method and a plurality of resources. The network interface is connected to a network. The processor is electrically connected to the network interface and the storage medium and runs the management program to execute the management method.

First, step 701 is executed to receive a first share request for sharing a first selected resource of the resources to a first target address via the network interface. Then, step 703 is executed to create a first share link of the first selected resource with an initial state for the first target address. Next, step 705 is executed to deliver the first share link to the first target address via the network interface.

Step 707 is executed to receive an activation request from a user device corresponding to the first target address via the network interface. The activation request includes an identification code and a user password corresponding to the first share link and the activation request is generated by the user device when accessing the cloud storage server via the first share link. Next, step 709 is executed to determine whether the identification code matches the first target address. Step 711 is then executed to transit the first share link from the initial state to an activated state if the identification code matches the first target address.

In other embodiments, the management method of the present invention may execute other steps (not shown) for more security which includes: creating an activation password of the first share link; determining whether an identification password included in the activation request matches the activation password; and transiting the first share link from the initial state to the activated state if the identification code matches the first target address and the identification password matches the activation password.

In other embodiments, the management method of the present invention may execute other steps (not shown) for aiding the receiver in managing his/her multiple contact addresses (i.e. target addresses) corresponding to the multiple share links. In this case, the steps include:
i. creating a user profile with a passkey of the first target address;
ii. receiving a first modification request with a second target address from the user device;
iii. creating a verification link for the second target address;
iv. delivering the verification link to the second target address via the network interface;
v. receiving a verification request with a verification code from a user device, wherein the verification message is generated by the user device when accessing the cloud storage server via the verification link;
vi. determining whether the verification code matches the passkey; and
vii. updating the user profile by linking the second target address with the first target address if the verification code matches the passkey.

Next, the steps may further include:
viii. receiving a second modification request with the password selection from the user device; and
ix. updating the user profile by the changing a same password option among multiple target addresses according to the second modification request.

Following that, in other embodiments, if a second selected resource is shared to a second target address of the same receiver, the management method of the present invention may further executes the following steps:
x. receiving a second share request for sharing the second selected resource of the resources to the second target address;
xi. determining whether the second target address includes in the user profile and further determining whether the second target address is linked with the first target address and set to the same user password if the second target address includes in the user profile;
xii. creating a second share link of the second selected resource with the activated state for the second target address if the second target address is linked with the first target address and set to the same user password; and
xiii. delivering the second share link to the second target address via the network interface.

Moreover, in other embodiments, if the first selected resource is also shared to a second target address at the same time, the management method of the present invention may further executes the following steps:
xiv. receiving the first share request for sharing the first selected resource of the resources to the first target address and the second target address;
xv. creating a second share link of the second selected resource with the initial state for the second target address;
xvi. delivering the second share link to the second target address via the network interface; and
xvii. transiting the second share link from the initial state to the activated state if the second target address is linked with the first target address and set to the same user password.

Besides, in other embodiment, the management method of the present invention may execute another step (not shown) when the share link is expired. In this case, the step is executed to permit downloading at least one old version of the first selected resource after the first share link is in an expired state, wherein the at least one old version of the first selected resource has been downloaded ever.

In addition to the aforesaid steps, the management method of this embodiment can also execute all the operations and functions set forth in the forgoing embodiments. The method in which this embodiment executes these operations and functions will be readily appreciated by those of ordinary skill in the art based on the explanation of the forgoing embodiments, and thus, will not be further described herein.

According to the above descriptions, the present invention provides a management mechanism for the receiver to set the self-defined password for the share link. Multiple contact addresses can also be linked together using the same user password. Furthermore, the management mechanism of the present invention permits the receiver to download the old version of a selected resource corresponding to a share link after the share link is expired as long as the old version of the selected resource has been downloaded ever.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cloud storage server, comprising:
a storage medium, being configured to store a management program and a plurality of resources;
a network interface connected to a network; and
a processor, being configured to run the management program to execute at least the following steps:
(a) receiving a first share request for sharing a first selected resource of the resources to a first target address via the network interface;
(b) creating a first share link of the first selected resource with an initial state for the first target address;
(c) delivering the first share link to the first target address via the network interface;
(d) receiving an activation request from a user device corresponding to the first target address via the network interface, wherein the activation request includes an identification code and a user password corresponding to the first share link and the activation request is generated by the user device when accessing the cloud storage server via the first share link;
(e) determining whether the identification code matches the first target address; and
(f) transiting the first share link from the initial state to an activated state if the identification code matches the first target address.

2. The management apparatus as claimed in claim 1, wherein the processor further executes the following steps:
creating an activation password of the first share link; and
determining whether an identification password included in the activation request matches the activation password; and
transiting the first share link from the initial state to the activated state if the identification code matches the first target address and the identification password matches the activation password.

3. The management apparatus as claimed in claim 1, wherein the processor further executes the following steps:
creating a user profile with a passkey of the first target address via the network interface;
receiving a first modification request with a second target address from the user device;
creating a verification link for the second target address;
delivering the verification link to the second target address via the network interface;
receiving a verification request with a verification code from a user device via the network interface, wherein the verification request is generated by the user device when accessing the cloud storage server via the verification link;
determining whether the verification code matches the passkey; and
updating the user profile by linking the second target address with the first target address if the verification code matches the passkey.

4. The management apparatus as claimed in claim 3, wherein the processor further executes the following steps:
receiving a second modification request with a password selection from the user device via the network interface; and
updating the user profile by the changing a same password option among multiple target addresses according to the second modification request.

5. The management apparatus as claimed in claim 4, wherein the processor further executes the following steps:
receiving a second share request for sharing a second selected resource of the resources to the second target address via the network interface;
determining whether the second target address includes in the user profile and further determining whether the second target address is linked with the first target address and set to the same user password if the second target address includes in the user profile;
creating a second share link of the second selected resource with the activated state for the second target address if the second target address is linked with the first target address and set to the same user password; and
delivering the second share link to the second target address via the network interface.

6. The management apparatus as claimed in claim 4, wherein the processor further executes the following steps:
receiving the first share request for sharing the first selected resource of the resources to the first target address and a second target address via the network interface;
creating a second share link of the first selected resource with the initial state for the second target address;
delivering the second share link to the second target address via the network interface; and
transiting the second share link from the initial state to the activated state if the second target address is linked with the first target address and set to the same user password.

7. The management apparatus as claimed in claim 1, wherein the processor further executes the following step:
permitting downloading at least one old version of the first selected resource after the first share link is in an expired state, wherein the at least one old version of the first selected resource has been downloaded ever.

8. A management method for use in a cloud storage server, the cloud storage server comprising a storage medium, a network interface and a processor, the storage medium storing a management program for the management method and a plurality of resources, the network interface being connected to a network, the processor being electrically connected to the network interface and the storage medium and running the management program to execute the management method, the management method comprising the steps of:
(a) receiving a first share request for sharing a first selected resource of the resources to a first target address via the network interface;
(b) creating a first share link of the first selected resource with an initial state for the first target address;
(c) delivering the first share link to the first target address via the network interface;
(d) receiving an activation request from a user device corresponding to the first target address via the network interface, wherein the activation request includes an identification code and a user password corresponding to the first share link and the activation request is generated by the user device when accessing the cloud storage server via the first share link;
(e) determining whether the identification code matches the first target address; and
(f) transiting the first share link from the initial state to an activated state if the identification code matches the first target address.

9. The management method as claimed in claim 8, further comprising the steps of:
creating an activation password of the first share link; and
determining whether an identification password included in the activation request matches the activation password; and
transiting the first share link from the initial state to the activated state if the identification code matches the first target address and the identification password matches the activation password.

10. The management method as claimed in claim 8, further comprising the steps of:
creating a user profile with a passkey of the first target address;
receiving a first modification request with a second target address from the user device via the network interface;
creating a verification link for the second target address;
delivering the verification link to the second target address via the network interface;
receiving a verification request with a verification code from a user device via the network interface, wherein the verification request is generated by the user device when accessing the cloud storage server via the verification link;
determining whether the verification code matches the passkey; and
updating the user profile by linking the second target address with the first target address if the verification code matches the passkey.

11. The management method as claimed in claim 10, further comprising the steps of:
receiving a second modification request with a password selection from the user device via the network interface; and
updating the user profile by the changing a same password option among multiple target addresses according to the second modification request.

12. The management method as claimed in claim 11, further comprising the steps of:
receiving a second share request for sharing a second selected resource of the resources to a second target address via the network interface;
determining whether the second target address includes in the user profile and further determining whether the second target address is linked with the first target address and set to the same user password if the second target address includes in the user profile;
creating a second share link of the second selected resource with the activated state for the second target address if the second target address is linked with the first target address and set to the same user password; and
delivering the second share link to the second target address via the network interface.

13. The management method as claimed in claim 11, further comprising the steps of:
receiving the first share request for sharing the first selected resource of the resources to the first target address and a second target address via the network interface;
creating a second share link of the second selected resource with the initial state for the second target address;
delivering the second share link to the second target address via the network interface; and
transiting the second share link from the initial state to the activated state if the second target address is linked with the first target address and set to the same user password.

14. The management method as claimed in claim 8, further comprising the steps of:
permitting downloading at least one old version of the first selected resource after the first share link is in an expired state, wherein the least one old version of the first selected resource has been downloaded ever.
